(19) United States
(12) Patent Application Publication
(10) Pub. No.: US 2006/0292312 A1
(43) Pub. Date: Dec. 28, 2006

(54) Method for forming fine patterns using soft mold

(75) Inventors: Jin Wuk Kim, Gyeonggi-do (KR); Mi Kyung Park, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd

(21) Appl. No.: 11/311,291

(22) Filed: Dec. 20, 2005

(30) Foreign Application Priority Data
Jun. 24, 2005 (KR) P 2005-55198

(51) Int. Cl. B05D 5/00; B05D 1/32; B05D 1/36; B29C 71/04

(52) U.S. Cl. 427/532; 427/402; 427/256; 427/282

(57) ABSTRACT

A method for forming a fine pattern using a soft mold includes forming the fine pattern on a substrate using the soft mold, treating the substrate, on which the fine pattern is formed, with plasma, and depositing at least one of an inorganic film and an organic film on the substrate on which the fine pattern is formed.

This application claims the benefit of the Korean Patent Application No. P2005-0055198 filed on Jun. 24, 2005, which is hereby incorporated by reference.

### BACKGROUND OF THE INVENTION

1. Field of the Invention

The present invention relates to a method of forming fine patterns, and more particularly to a method for forming fine patterns using a soft mold for use in fabricating electronic circuit boards.

2. Discussion of the Related Art

The process for forming a fine pattern in an electronic circuit serves as an important factor that affects characteristics of an electronic device and determines performance and capacity of the device. Recently, many efforts have been made to improve performance of electronic devices. Particularly, studies for improving performance of the device by forming a fine pattern have been actively pursued. The process for forming a fine pattern is generally used for printed circuit boards (PCBs) and flat panel display devices, such as a liquid crystal display (LCD) device and a plasma display panel (PDP) device.

Among various processes for forming a pattern, a solution-based process for forming a pattern has been widely used, in which an exposure process is used to grow only a selective region. However, the solution-based patterning process has limitations in handling variable physical properties of a nano material. Furthermore, an inkjet printing type process for forming a pattern may be performed to form a pattern in only a desired region. In this case, it is difficult to form a nano material. To form the nano material, the process for forming a barrier is required, thereby complicating the whole process.

### SUMMARY OF THE INVENTION

Accordingly, the present invention is directed to a method for forming a fine pattern, which substantially obviates one or more problems due to limitations and disadvantages of the related art.

An object of the present invention is to provide a method for forming a fine pattern using a soft mold in which a surface treatment technique suitable for matching is used.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for forming a fine pattern using a soft mold includes forming the fine pattern on a substrate using the soft mold, treating the substrate, on which the fine pattern is formed, with plasma, and depositing at least one of an inorganic film and an organic film on the substrate on which the fine pattern is formed.

In another aspect, a method for forming a fine pattern using a soft mold includes arranging the soft mold on a substrate on which a solidified material film is formed, contacting the soft mold with the solidified material film to form the fine pattern, stripping the soft mold from the substrate, treating the substrate, on which the fine pattern is formed, with plasma, and depositing at least one of an inorganic film and an organic film on the substrate on which the fine pattern is formed.

In yet another aspect, a method for forming a fine pattern using a soft mold includes arranging the soft mold on a substrate on which a liquid material film is formed contacting the soft mold with the liquid material film to form the fine pattern, curing the fine pattern, stripping the soft mold from the substrate, treating the substrate, on which the fine pattern is formed, with plasma, and depositing at least one of an inorganic film and an organic film on the substrate on which the fine pattern is formed.

In still yet another aspect, a method for forming a fine pattern using a soft mold includes arranging the soft mold, which is coated with a nano material on an embossed surface, on a substrate, printing the nano material coated on the soft mold on the substrate to form the fine pattern, treating the substrate, on which the fine pattern is formed, with plasma, and coating at least one of an inorganic film and an organic film on the substrate on which the fine pattern is formed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A to FIG. 1D are sectional views illustrating process steps of fabricating a soft mold for first and second exemplary embodiments of the present invention;

FIG. 2A and FIG. 2B are sectional views illustrating process steps of fabricating a soft mold for a third exemplary embodiment of the present invention;

FIG. 3 is graph illustrating a contact angle of a fine pattern depending on the number of times of use of a soft mold;

FIG. 4A to FIG. 4F are sectional views illustrating process steps of fabricating a soft mold according to the first and second exemplary embodiments of the present invention with a surface treatment technique of the present invention;

FIG. 5A to FIG. 5D are sectional views illustrating process steps of fabricating a soft mold according to the third exemplary embodiment of the present invention with a surface treatment technique of the present invention;

FIG. 6 is a graph illustrating variation of a contact angle depending on pressure, power, and time during plasma treatment; and

FIG. 7A and FIG. 7B illustrate contact degrees before and after plasma treatment.

It will be apparent to those skilled in the art that various modifications and variations can be made in the method of forming fine patterns of the present invention without departing from the spirit or scope of the invention. Thus, it is intended that the present invention cover the modifications and variations of this invention provided they come within the scope of the appended claims and their equivalents.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

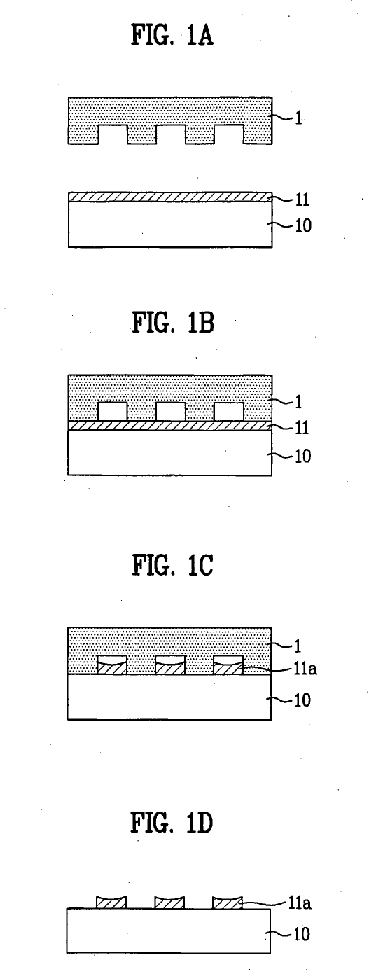

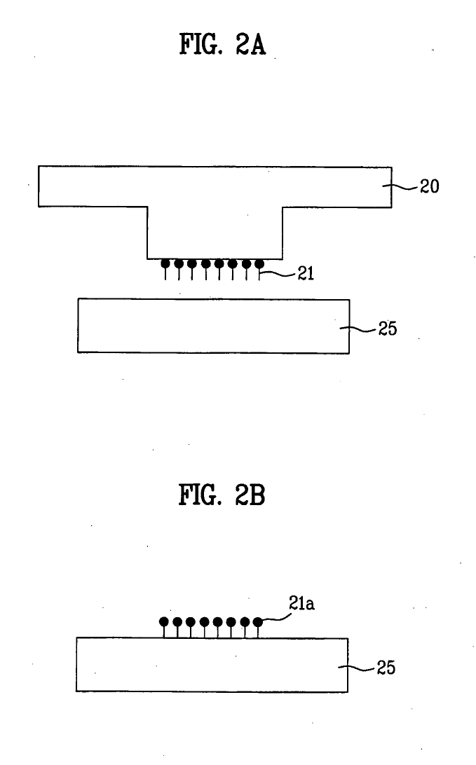

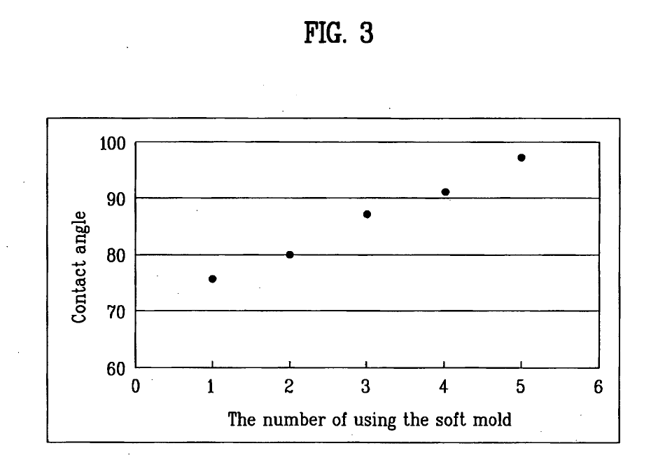

First, a method for forming a fine pattern using a soft mold will be described. FIG. 1A to FIG. ID are sectional views illustrating process steps of fabricating a soft mold for first and second exemplary embodiments of the present invention, FIG. 2A and FIG. 2B are sectional views illustrating process steps of fabricating a soft mold for a third exemplary embodiment of the present invention, and FIG. 3 is a graph that illustrates a contact angle of a fine pattern depending on the number of times of use of a soft mold.

A method for forming a fine pattern using a soft mold for the first exemplary embodiment of the present invention is based on capillary force lithography (CFL). As shown in FIG. 1A, a soft mold 1 having a surface embossed or concaved with a predetermined shape is arranged on a substrate 10 coated with a solidified nano material film 11.

Next, as shown in FIG. 1B, the soft mold 1 contacts the solidified nano material film 11. As shown in FIG. 1C, when the soft mold 1 contacts the solidified nano material film 11, concave portions of the soft mold 1 becomes partially filed with the solidified nano material film 11 such that a fine pattern 11a is formed on the substrate 10. Subsequently, as shown in FIG. 1D, the soft mold 1 is stripped from the substrate 10 on which the fine pattern 11a is formed.

In addition to the aforementioned capillary force lithography (CFL), a method for forming a fine pattern using a soft mold for a second exemplary embodiment of the present invention may be performed based on in-plane printing (IPP). The method for forming a fine pattern using a soft mold for the second exemplary embodiment of the present invention based on in-plane printing (IPP) is performed in the same manner as that of the first exemplary embodiment except for the following steps. In particular, the second exemplary embodiment is different from the first exemplary embodiment in that the solidified nano material film of the first embodiment is replaced with a liquid nano material film. The soft mold 1 contacts the liquid nano material film 11. The concave portions of the soft mold 1 filled with the liquid nano material film 11 undergo UV-curing or thermal-curing to form the fine pattern 11a.

A method for forming a fine pattern using a soft mold for a third exemplary embodiment of the present invention is based on micro-contact printing. As shown in FIG. 2A, an embossed surface of a soft mold 20 is coated with a nano material 21 for forming a pattern. The soft mold 20 coated with the nano material 21 is arranged on a substrate 25 for forming a fine pattern. Then, as shown in FIG. 2B, the nano material 21 coated on the embossed surface of the soft mold 20 is printed on the substrate 25 to form a fine pattern 21a.

The soft mold 20 used for the above processes is used to form a fine pattern of a micro unit. The soft mold 20 can be fabricated by curing an elastic polymer. In this case, PDMS is widely used as the elastic polymer. In addition to the nano material for forming the pattern, polyaniline or a conductive high polymer such as PEDOT:PSS may be used as the material for forming the pattern.

If the nano material such as a nano tube and a nano-particle is formed on a desired substrate using the soft mold of PDMS to form the fine pattern, the fine pattern in contact with the soft mold is minimized. As shown in FIG. 3, a contact angle of the fine pattern increases as the number of times the soft mold is used, i.e., the number of times the soft mold contacts the fine pattern, increases. The increase in contact angle decreases the precision of the fine patterns resulting in the fine patterns having a round, beaded shape. If the contact angle between the soft mold and the fine pattern increases as the fine pattern is minimized, when an inorganic matter or an organic matter is deposited on the fine pattern, adhesion between the nano material and the inorganic film is reduced while de-wetting between the nano material and an organic film occurs.

To overcome this problem, the present invention also includes a surface treatment technique to improve adhesion between the fine pattern and the inorganic film to prevent de-wetting between the fine pattern and the organic film in case where the nano material is formed on a desired substrate to form the fine pattern using the soft mold of PDMS based on capillary force lithography, in-plane printing, or micro-contact printing. Hereinafter, an exemplary method for forming a fine pattern using a soft mold according to the present invention will be described with reference to the accompanying drawings.

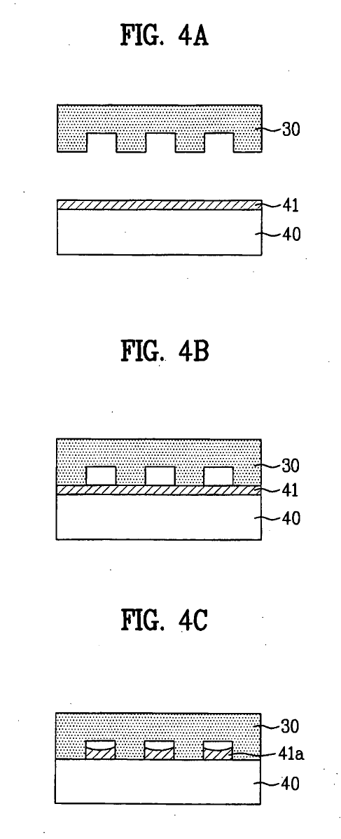

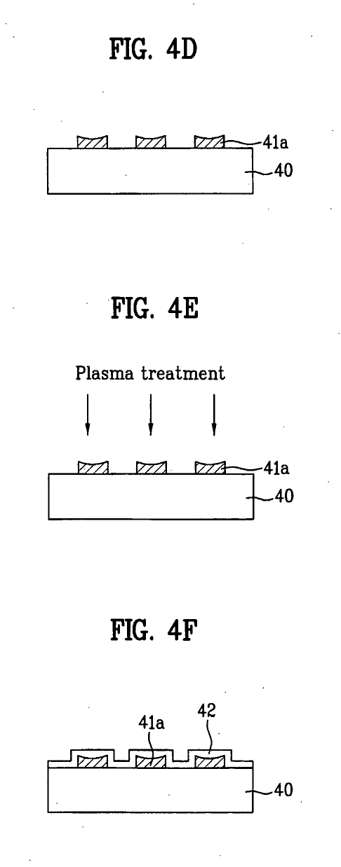

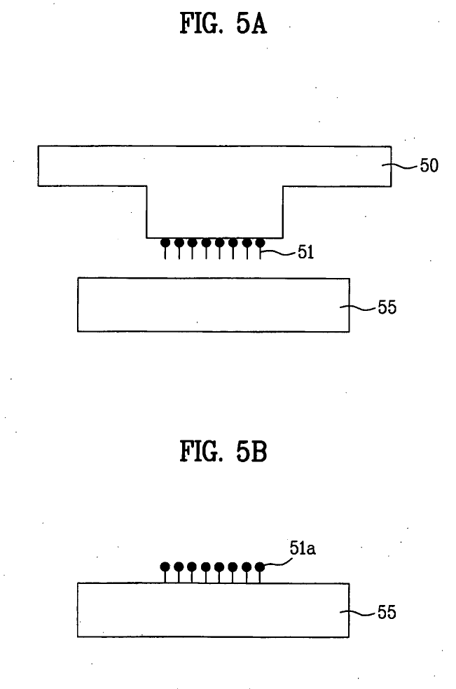

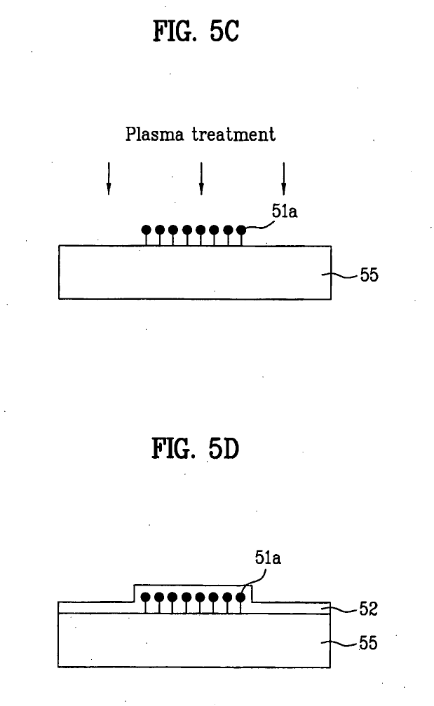

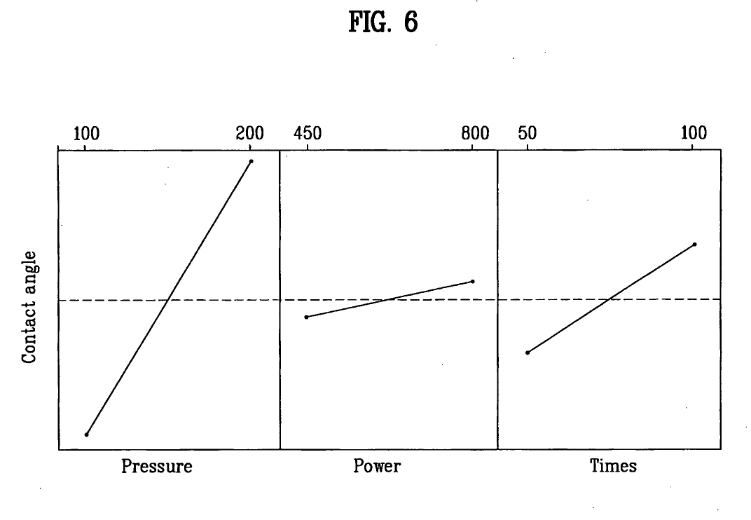

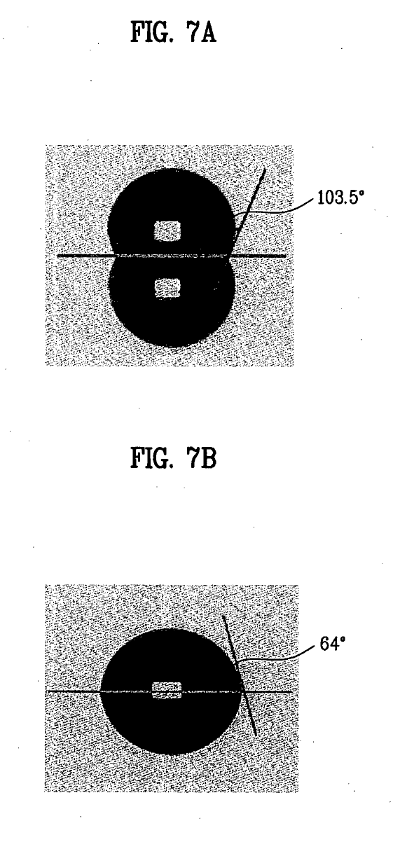

FIG. 4A to FIG. 4F are sectional views illustrating process steps of fabricating a soft mold according to the first and second exemplary embodiments of the present invention including a surface treatment technique of the present invention. FIG. 5A to FIG. 5D are sectional views illustrating process steps of fabricating a soft mold according to the third exemplary embodiment of the present invention including a surface treatment technique of the present invention. FIG. 6 illustrates variation of a contact angle depending on pressure, power, and time during plasma treatment, and FIG. 7A and FIG. 7B illustrate contact degrees before and after plasma treatment.

In the method for forming a fine pattern using a soft mold according to the first exemplary embodiment of the present invention based on capillary force lithography, FIG. 4A illustrates a soft mold 30 having a surface embossed or concaved with a predetermined shape arranged on a substrate 40 coated with a solidified nano material film 41. The soft mold 30 is used to form a fine pattern of a micro unit. The soft mold can be fabricated by curing an elastic polymer. In this case, PDMS is widely used as the elastic polymer. In addition to the nano material for forming the pattern, polyaniline or a conductive high polymer such as PEDOT:PSS may be used as the material for forming the pattern.

Next, as shown in FIG. 4B, the soft mold 30 contacts the solidified nano material film 41. If the soft mold 30 contacts the solidified nano material film 41, as shown in FIG. 4C, concave portions of the soft mold 30 is partially filled with the solidified nano material film 41 such that a fine pattern 41a is formed on the substrate 40. Subsequently, as shown in FIG. 4D, the soft mold 30 is stripped from the substrate 40 on which the fine pattern 41a is formed.

Then, as shown in FIG. 4E, surface of the substrate 40 on which the fine pattern 41a is formed is treated with plasma. The plasma treatment is to mitigate the increase in the contact angle between the fine pattern 41a and the surface of the substrate 40 due to the minimized surface of the fine pattern 41a when the fine pattern 41a is formed using the soft mold 30 of PDMS. The plasma treatment is performed using O₂, Ar, H₂, corona or He. Then, as shown in FIG. 4F, an inorganic film 42 is coated on the substrate 40 on which the fine pattern 41a is formed. Alternatively, instead of the inorganic film 42, an organic film may be coated.

The method for forming a fine pattern using a soft mold for the second exemplary embodiment of the present invention based on in-plane printing is performed in the same manner as that of the first embodiment except for the following steps. That is, the second exemplary embodiment is different from the first exemplary embodiment in that the solidified nano material film of the first embodiment is replaced with a liquid nano material film. The soft mold 30 contacts the liquid nano material film 41. The concave portions of the soft mold filled with the liquid nano material film 41 undergo UV-curing or thermal-curing to form the fine pattern 41a.

Next, the method for forming a fine pattern using a soft mold for the third exemplary embodiment of the present invention based on micro-contact printing is explained. As shown in FIG. 5A, an embossed surface of a soft mold 50 is coated with a nano material 51 for forming a pattern. The soft mold 50 coated with the nano material 51 is arranged on a substrate 55 for forming a fine pattern. Then, as shown in FIG. 5B, the nano material 51 coated on the soft mold 50 is printed on the substrate 55 to form a fine pattern 51a.

The soft mold 50 is used to form a fine pattern of a micro unit. The soft mold 50 can be fabricated by curing an elastic polymer. In this case, PDMS is widely used as the elastic polymer. In addition to the nano material for forming the pattern, polyaniline or a conductive high polymer such as PEDOT:PSS may be used as the material for forming the pattern.

Next, as shown in FIG. 5C, surface of the substrate 55 on which the fine pattern 51a is formed is treated with plasma. The plasma treatment is to mitigate the increase of the contact angle between the fine pattern 51a and the surface of the substrate 55 due to the minimized surface of the fine pattern 51a when the fine pattern 51a is formed using the soft mold 50 of PDMS. The plasma treatment is performed using O₂, Ar, H₂, corona or He. Then, as shown in FIG. 5D, an inorganic film 52 is coated on the substrate 55 on which the fine pattern 51a is formed. Alternatively, instead of the inorganic film 52, an organic film may be coated.

As described in the first to third exemplary embodiments of the present invention, it is noted that surface wetting increases and the contact angle of the fine pattern is reduced if plasma treatment is performed after the fine pattern is formed on the substrate. Hereinafter, variations in the contact angle depending on pressure, power, and time during H₂ plasma treatment will be described.

First, a flow rate of H₂ is in the range of 100 sccm during H₂ plasma treatment. Also, the H₂ plasma treatment is performed under the pressure of 100 mTorr to 200 mTorr, the power of 400 W to 800 W, and the time of 50 sec to 100 sec.

If the fine pattern is treated with plasma as described above, it is noted that the contact angle is reduced further when the pressure is in the range of 100 mTorr than when the pressure is in the range of 200 mTorr as shown in FIG. 6. The contact angle is reduced further when the power is in the range of 400 W than when the power is in the range of 800 W, and the contact angle is reduced further when the plasma treatment time is in the range of 50 sec than when the time is in the range of 100 sec.

When the fine pattern is formed using the soft mold of PDMS, differences in the contact angle when the fine pattern is treated with H₂ plasma and when the fine pattern is not treated with H₂ plasma are as follows. First, as shown in FIG. 7A, if the fine pattern is not treated with H₂ plasma after it is formed using the soft mold of PDMS, the contact angle is substantially in the range of 103.5° and has a round shape resembling beaded water drop. In contrast, as shown in FIG. 7B, if the fine pattern is treated with H₂ plasma after it is formed using the soft mold of PDMS, the contact angle is reduced to reach 64° and has a shape resembling a spreading water drop. Since the contact angle is reduced by the plasma treatment, it is possible to improve adhesion between the fine pattern and the inorganic film when the inorganic film is deposited on the fine pattern to form the device and avoid de-wetting between the fine pattern and the organic film when the organic film is deposited on the fine pattern to form the device.

As described above, the method for forming the fine pattern using the soft mold according to the present invention has the following advantages. In case where the fine pattern is formed on the substrate using the soft mold of PDMS, the fine pattern is treated with plasma to attenuate the contact angle due to the minimized surface of the fine pattern. Therefore, it is possible to improve adhesion between the fine pattern and the inorganic film when the inorganic film is deposited on the fine pattern to form the device and avoid de-wetting between the fine pattern and the organic film when the organic film is deposited on the fine pattern to form the device.

It will be apparent to those skilled in the art that various modifications and variations can be made in the method of forming fine patterns of the present invention without departing form the spirit or scope of the invention. Thus, it is intended that the present invention cover the modifications and variations of this invention provided they come within the scope of the appended claims and their equivalents.

What is claimed is:

1. A method for forming a fine pattern using a soft mold, comprising:
forming the fine pattern on a substrate using the soft mold;
treating the substrate, on which the fine pattern is formed, with plasma; and
depositing at least one of an inorganic film and an organic film on the substrate on which the fine pattern is formed.

2. The method as claimed in claim 1, wherein the fine pattern is formed based on one of capillary force lithography, in-plane printing, and micro-contact printing techniques.

3. The method as claimed in claim 1, wherein the substrate is treated with plasma using at least one of O₂, Ar, H₂, corona, and He.

4. The method as claimed in claim 3, wherein the substrate is treated with plasma using H₂ in the range of a flow rate of approximately 100 sccm, pressure of approximately 100 mTorr to approximately 200 mTorr, power of approximately 400 W to approximately 800 W, and time of approximately 50 sec to approximately 100 sec.

5. The method as claimed in claim 1, wherein the soft mold is embossed or concaved with a predetermined shape on a surface and is made of polydimethylsiloxane (PDMS).

6. A method for forming a fine pattern using a soft mold, comprising:
arranging the soft mold on a substrate on which a solidified material film is formed;
contacting the soft mold with the solidified material film to form the fine pattern;
stripping the soft mold from the substrate;
treating the substrate, on which the fine pattern is formed, with plasma; and
depositing at least one of an inorganic film and an organic film on the substrate on which the fine pattern is formed.

7. The method as claimed in claim 6, wherein the solidified material film is made of at least one of a nano material, polyaniline, and a conductive high polymer such as PEDOT:PSS.

8. The method as claimed in claim 6, wherein the substrate is treated with plasma using at least one of O₂, Ar, H₂, corona, and He.

9. The method as claimed in claim 8, wherein the substrate is treated with plasma using H2 in the range of a flow rate of approximately 100 sccm, pressure of approximately 100 mTorr to approximately 200 mTorr, power of approximately 400 W to approximately 800 W, and time of approximately 50 sec to approximately 100 sec.

10. The method as claimed in claim 6, wherein the soft mold has a surface which is embossed or concaved with a predetermined shape, and is made of polydimethylsiloxane (PDMS).

11. A method for forming a fine pattern using a soft mold, comprising:
arranging the soft mold on a substrate on which a liquid material film is formed;
contacting the soft mold with the liquid material film to form the fine pattern;
curing the fine pattern;
stripping the soft mold from the substrate;
treating the substrate, on which the fine pattern is formed, with plasma; and
depositing at least one of an inorganic film and an organic film on the substrate on which the fine pattern is formed.

12. The method as claimed in claim 11, wherein the substrate is treated with plasma using at least one of O₂, Ar, H₂, corona, and He.

13. The method as claimed in claim 11, wherein the soft mold has a surface which is embossed or concaved with a predetermined shape, and is made of polydimethylsiloxane (PDMS).

14. The method as claimed in claim 11, wherein the fine pattern is UV-cured or thermally cured.

15. A method for forming a fine pattern using a soft mold, comprising:
arranging the soft mold, which is coated with a nano material on an embossed surface, on a substrate;
printing the nano material coated on the soft mold on the substrate to form the fine pattern;
treating the substrate, on which the fine pattern is formed, with plasma; and
coating at least one of an inorganic film and an organic film on the substrate on which the fine pattern is formed.

16. The method as claimed in claim 15, wherein the soft mold is made of PDMS.

17. The method as claimed in claim 15, wherein the substrate is treated with plasma using at least one of O₂, Ar, H₂, corona, and He.

18. The method as claimed in claim 15, further comprising printing polyaniline or a conductive high polymer such as PEDOT:PSS on the substrate.
